(19) United States
(12) Patent Application Publication
(10) Pub. No.: US 2025/0076468 A1
(43) Pub. Date: Mar. 6, 2025

(54) SOLID-STATE LIDAR DEVICE AND SCANNING METHOD BASED ON A TUNABLE LASER OUTPUT ARRAY

(71) Applicant: Zhejiang University, Hangzhou (CN)

(72) Inventors: Jianjun HE, Hangzhou (CN); Kai CHANG, Hangzhou (CN); Sen ZHANG, Hangzhou (CN); Jiajun HU, Hangzhou (CN)

(21) Appl. No.: 18/954,365

(22) Filed: Nov. 20, 2024

(30) Foreign Application Priority Data
May 29, 2024 (CN) 202410679069.5

(51) Int. Cl. G01S 7/481

(52) U.S. Cl. CPC G01S 7/4815; G01S 7/4817

(57) ABSTRACT

The present invention discloses a solid-state LiDAR device and a scanning method based on a tunable laser array. The array sequentially emits laser beams of different wavelengths, collimated by a collimating lens, and passes through a beam splitter. The beams are then diffracted by a blazed grating and focused by the first focusing lens onto the focal plane of the transmitting lens, and then emitted through the transmitting lens as collimated beams in different directions for wide area scanning. The optical receiving path uses the reversed coaxial system, where the received light returns to the beam splitter, redirects to the second focusing lens, and is finally focused on the detector. This invention incorporates tunable laser arrays, optical systems and dispersion devices to realize a solid-state wide-area scanning LiDAR device without moving parts, offering a wide scanning range, small size and fast scanning speed.

### CROSS-REFERENCE TO RELATED APPLICATIONS

This application claims the benefit of priority from Chinese Patent Application No. 202410679069.5, filed on May 29, 2024. The content of the aforementioned application, including any intervening amendments thereto, is incorporated herein by reference in its entirety.

### FIELD

The present invention relates to the field of radar devices, and more particularly to a solid-state LiDAR device and scanning method.

### BACKGROUND INFORMATION

Time-of-Flight (TOF) LiDAR acquires distance information about the surrounding environment quickly and conveniently, while Frequency-Modulated Continuous Wave (FMCW) LiDAR also captures velocity information of nearby objects, earning it the title “robot's eye.” The current LiDAR market, both domestically and internationally, mainly consists of semi-solid MEMS LiDAR and mechanical scanning LiDAR. The high-speed moving parts of such LIDAR will gradually wear out and fail with the accumulation of time, and the stability of the system is susceptible to external factors such as temperature, vibration and so on. However, solid-state LiDAR can better overcome these drawbacks. Solid-state LiDAR solutions are divided into Flash LiDAR schemes, Optical Phased Array (OPA) schemes, and scanning schemes based on grating diffraction and lenses. Flash LiDAR must illuminate the entire scene at once, resulting in energy being uniformly distributed across the measurement area. Due to power limitations, it can only be used for short-range detection. The OPA solution has not been commercially applied due to high power consumption, sidelobe issues, and complex manufacturing processes. Scanning schemes based on grating and lens diffraction often have high requirements for the wavelength tuning range of the laser, thus limiting the scanning range of the LiDAR.

### SUMMARY

In view of the defects in the prior art, the present invention provides an solid-state LiDAR device and scanning method based on a tunable laser output array. The present invention realizes a solid-state, large-range scanning LiDAR device without moving parts by using a tunable laser output array in combination with an optical system and dispersion devices, which has a large scanning range, a small size, and a fast scan speed.

The technical program of the invention is as follows:
I. A solid-state LiDAR scanning device
Said solid-state LiDAR device includes a tunable laser output array, a collimating lens unit, a beam splitter unit, a grating, a focusing lens unit one, an transmitting lens unit, a focusing lens unit two and a detector.

The tunable laser output array emits N-channel outgoing laser, which are respectively collimated by the collimating lens unit. And then N-channel outgoing laser are transmitted through the beam splitter unit to the grating, where diffraction occurs. After diffraction, they are focused by the focusing lens unit one and then refracted by the transmitting lens unit to become the N-channel scanning laser. The scanning laser generated by different wavelengths of the emitted laser has different propagation directions. The scanning laser generated by the same wavelengths of the emitted laser has a parallel direction of propagation. When the N-channel scanning laser is emitted to the scanning area, it is diffusely reflected by the objects in the scanning area and generates the N-channel return laser respectively. After returning to the beam splitter unit along the original path, the N-channel return laser is reflected to the focusing lens unit two, and then focused to the detector. The detector is used to receive the N-channel return laser and convert it into electric signal.

The reverse process of each return laser is as follows: each way back to the original laser path are first refracted by the transmitting lens unit, and then focused by the focusing lens unit to the grating where diffraction occurs, and finally the diffracted return laser light is reflected by the beam splitter unit.

Said tunable laser output array is electrically connected to an external controller and is controlled by the controller to control its own operating parameters, said operating parameters including the actual wavelength tuning range of individual lasers, the timing control parameters of individual lasers and the like. Said detector is electrically connected to the external controller and outputs signals carried in the return laser to the controller.

Specifically, said outgoing laser is polarized light. On the transmitting optical path, wherein the outgoing lasers having the same wavelength are emitted as scanning lasers in the same propagation direction by the transmitting lens unit. Said scanning lasers are collimated beams. When the N-channel outgoing lasers each have m different wavelengths, the N-channel outgoing lasers each correspond to generating N scanning lasers distributed in m propagation directions. The difference between the maximum wavelength and the minimum wavelength is positively correlated with the scanning range angle between the scanning lasers.

Specifically, said solid-state LiDAR device is a transceiver coaxial optical path system, wherein in the receiving optical path, said return laser is refracted by the transmitting lens unit, and the propagation direction of the return laser is parallel to the outgoing direction of the outgoing laser. Said solid-state specifically means that the entire system does not include any mechanically moving parts.

Wherein said tunable laser output array comprises a plurality of lasers arranged in several arrays. Said lasers array in the focal plane of the collimated lens unit, said collimated lens unit being disposed on the light-emitting side of the tunable laser output array. Said tunable laser output array comprises N tunable lasers arranged in several arrays along a P×Q matrix. The row direction of said P×Q matrix is parallel to the grating grooves of the grating, and the column direction is perpendicular to the grating grooves of the grating. The total number of rows P and total number of columns Q are both greater than or equal to 1, but are not 1 at the same time. The Q tunable lasers in the same row have the same wavelength tuning range, and the P tunable lasers in the same column have K different wavelength tuning ranges respectively. The K different wavelength tuning ranges are superimposed to cover or equal to the predetermined total wavelength tuning range, and K is less than or equal to the total number of rows P.

Wherein the focal plane of the transmitting lens unit is the focal plane of the incident side of the outgoing laser.

Wherein said total wavelength tuning range is a continuous interval.

Preferably, any two adjacent tunable lasers are equally spaced apart from each other.

Optionally, each tunable laser is wavelength continuously tuned or discontinuously tuned.

Preferably, said tunable laser is a side emitting semiconductor laser. The total number of rows P is 1 and the detector is a line array detector. As an optional embodiment of the present invention, the total number of rows P is 1, and said tunable laser output array comprises 1×Q side-emitting semiconductor lasers. The Q side-emitting semiconductor lasers are arranged at an equal spacing along the row direction, said row direction being parallel to the grating grooves. The Q side-emitting semiconductor lasers have the same wavelength tuning range. All outgoing lasers are focused on the focal plane of the transmitting lens unit and form several line light spots in the focal plane. Each line light spot is generated by the same wavelength of the outgoing laser emitted by the emitting diode laser from different sides. Said detector is a line array detector. The detection area of the solid-state LiDAR device is a two-dimensional plane region, which is parallel to the focal plane of the transmitting lens unit. In the slow-axis direction, the size of the spot focused onto the detector through the focusing lens unit two corresponds to the length of the line array detector. In the fast-axis direction, the spot size focused onto the detector through the focusing lens unit two is smaller than the width of the line array detector.

Alternatively, said tunable laser is a side-emitting semiconductor laser. The total number of columns Q is 1 and the detector is a single point detector. As another alternative embodiment of the present invention, the total number of columns Q is 1. Said tunable laser output array comprises P×1 side-emitting semiconductor lasers. The P side-emitting semiconductor lasers are arranged at an equal spacing along a column direction. Said column direction is perpendicular to grating grooves. The N side-emitting semiconductor lasers have K different wavelength tuning ranges, K being less than or equal to (preferably) N. The outgoing laser light with the same wavelength emitted from different side-emitting semiconductor lasers is focused to the focal plane of the transmitting lens unit to form a focusing point. The outgoing laser light emitted from all side emitting semiconductor lasers with different wavelengths is focused to the focal plane of the transmitting lens unit to form several focusing points. The detector is a single-point detector. At this time, the scanning area of the solid-state LiDAR device is a one-dimensional linear area. Said one-dimensional straight line is perpendicular to the direction of the above line light spot, and the width of said one-dimensional linear region is positively correlated with the total wavelength tuning range.

In the above optional embodiments, the wavelength tuning range of said side-emitting semiconductor lasers is achieved by modifying quantum wells in the active region of each side-emitting semiconductor laser. By utilizing quantum well hybridization techniques, the wavelength tuning range of each tunable laser can be further altered. Quantum well hybridization techniques alter the material band gap in the active region of the tunable laser to alter the wavelength tuning range of the tunable laser.

In said solid-state LiDAR scanning device, said grating is a blazed grating.

In said solid-state LiDAR scanning device, said collimating lens unit/focusing lens unit one/transmitting lens unit/focusing lens unit two all comprise a plurality of lenses, said lenses being aspherical lenses, cylindrical lenses, or spherical lenses, and said lenses being coated with a reflectance-enhancing film or uncoated.

In solid-state LiDAR scanning device, said beam splitter unit comprises a polarizing beam splitter prism and a quarter-wave plate. Said polarizing beam splitter prism and the quarter-wave plate are arranged sequentially along the propagation direction of the outgoing laser. Said outgoing laser light is transmitted by the polarizing beam splitter prism and then transmitted to the grating through the quarter-wave plate. Said return laser light passes through the quarter-wave plate and then is reflected through the polarizing beam splitter prism to the focusing lens unit two. Said outgoing laser light is used as a first polarized light and said returning laser light after passing through the quarter wave plate in the beam splitter unit is used as a second polarized light. The polarization direction of said first polarized light is perpendicular to the polarization direction of the second polarized light. In addition, after the return laser light is reflected by the polarized beam splitter prism in the beam splitter unit, the propagation direction is perpendicular to the outgoing direction of the outgoing laser light.

In said solid-state LiDAR scanning device, said solid-state LiDAR scanning device further comprises a reflecting unit, the reflecting unit comprising one or a combination of one or more of aspherical, cylindrical, spherical, planar mirrors and reflecting gratings for changing the direction of the optical path in the system. Said reflecting unit is disposed at an arbitrary position between the laser output array and the scanning area. Said solid-state LiDAR scanning device further comprises a beam expander and beam reducer unit, the beam expander and beam reducer unit comprising a combination of one or more of aspherical, cylindrical, spherical lenses and planar mirrors, used for changing the aperture of the optical path in the system. Said beam expander and reducer unit is disposed at an arbitrary position between the laser output array and the scanning area.

II. A scanning method using the above-described solid-state LiDAR scanning device

Said scanning method specifically includes as follows:
(S1) Turn on said solid-state LiDAR device and pre-set scanning parameters according to a ranging method, wherein said ranging method is TOF method or FMCW method.
(S2) The individual tunable lasers in the laser output array are tuned in their respective wavelength tuning ranges and emit outgoing lasers of different wavelengths in a chronological order. Said tuning is discontinuous or continuous, and the wavelengths of said outgoing lasers all fall within a pre-set total wavelength tuning range. After sequentially passing through the collimating lens unit and beam splitter unit, each outgoing laser is diffracted when incident in the grating to generate a diffracted laser. The diffracted laser is incident on the focusing lens unit one and then focused into a focused laser. The focused laser is incident on the focal plane of the transmitting lens unit, and a scanning laser is generated after being refracted by the transmitting lens unit. The scanning laser is irradiated to the object in the scanning area, and the return laser is formed by diffuse reflection. The return laser is collected by the detector after passing through the transmitting lens unit, the focusing lens unit one, the grating, the beam splitter unit, and the focusing lens unit two in turn.

Preferably, in said step (S2) the individual tunable lasers have the same wavelength tuning period.

In said step (S2), when there is only one column of tunable lasers having the same wavelength tuning range, outgoing lasers emitted from the same column of tunable lasers having the same wavelength form a single line light spot on the focal plane of the transmitting lens unit and outgoing lasers of different wavelengths form a plurality of parallel spaced line light spot. When there is only one row of tunable lasers, outgoing lasers emitted from the same row of tunable lasers having the same wavelength form a point spot on the focal plane of the transmitting lens unit, and outgoing lasers having different wavelengths form a plurality of point spots, said point spots being arranged along a straight line, said straight line direction being perpendicular to the direction of the line light spots.
(S3) Said detector converts the collected return laser light into an electrical signa and transmits it to an external controller. Said controller processes the signal to generate a scan result.
(S4) At the end of the scanning, turn off said solid-state LiDAR device.

Specifically, when there is only one array of tunable lasers having the same wavelength tuning range, scanning in a first dimension is realized in the fast-axis direction by wavelength tuning, and scanning in a second dimension is realized in the slow-axis direction by a tunable laser output array. Said direction of the first dimension is perpendicular to the direction of the second dimension. In the slow-axis transmitting optical path, the outgoing laser light emitted by all the tunable lasers having the same wavelength forms a line light spot in the focal plane of the transmitting lens unit. In the fast-axis transmitting optical path, the distance between the two line light spots corresponding to the minimum and maximum wavelength outgoing laser respectively, is the scanning spans s, wherein said scanning span is s=2*f₄*tan(Δγ/2). Wherein f₄ is the focal length of the focusing lens unit one. Said first direction and second direction are perpendicular to each other, and both the first direction and the second direction are parallel to the focal plane of the transmitting lens unit. When there is only one row of tunable lasers, the P tunable lasers have a plurality of different wavelength tuning ranges, which can be spliced together to form or cover a continuous total wavelength tuning range. A larger range of linear scanning regions can be realized by broadening the total wavelength tuning range, said linear scanning region being parallel to the second direction.

The beneficial effects of the present invention are as follows:
(1) The present invention uses a tunable laser output array as a light source. The tunable laser output array includes tunable lasers with different wavelength tuning ranges, and by superposing the wavelength tuning ranges of all the tunable lasers a wider wavelength tuning range is obtained. By combining the wider wavelength tuning range with the laser array in the structure of the present invention, a scanning beam with a larger scanning angle is obtained. It can realize that the laser beam is scanned in different directions and dimensions.
(2) The present invention proposes to perform multiple quantum wells mixing of the semiconductor laser chip to improve the overall wavelength scanning range of its array output. In combination with this solid-state LiDAR scanning system, a wider angular range of scans can be achieved when the array is arranged in a direction perpendicular to the grating grooves. Compared to existing technologies, the scanning range is greatly improved. When the alignment direction of the semiconductor laser array chip is parallel to the grating grooves direction of the array laser, the present invention in the fast-axis direction through the wavelength tuning achieves a dimension of scanning, and in the slow-axis direction through the laser array forms a line light spot to do another dimension of irradiation, thus realizing the two-dimensional LiDAR scanning effect.
(3) The device of the present invention adopts a side-emitting semiconductor laser as a laser light source and combines quantum well mixing technology to obtain tunable laser arrays with different wavelength tuning ranges, which are simple to fabricate, low-cost, and have a wider application prospect.
(4) The present invention utilizes a coaxial optical path receiving system, which improves the system's immunity to interference, compactness, and reduces the cost of the device.
(5) The structure of the present invention adopts the combination of multiple lenses, mirrors and gratings to realize the effect of large-range and multi-dimensional scanning. The scanning beams with different scanning angles can be obtained without moving parts, which further improves the stability of the system and makes the LiDAR transmitter device low-cost, lightweight and small.
(6) The scanning direction change rate in the present invention is equal to the wavelength tuning rate, which is on the order of microseconds. The scanning rate is greatly improved relative to MEMS as well as mechanically rotating LiDAR.

### BRIEF DESCRIPTION OF THE DRAWINGS

FIG. 1 illustrates the tunable laser output array in Embodiment 1 of the present invention;

FIG. 2 illustrates the wavelength stitching range of the tunable laser output array in Embodiment 1 of the present invention;

FIG. 3 illustrates the tunable laser output array in Embodiment 2 of the present invention;

FIG. 4 illustrates the overall architecture of the present invention;

FIG. 5 illustrates the principle of blazed grating diffraction;

FIG. 6 illustrates the transmitting optical path in the fast and slow-axis directions in Embodiment 2 of the present invention;

FIG. 7 illustrates the receiving optical path in the fast and slow-axis directions in Embodiment 2 of the present invention. In FIG. 7, 1 represents the laser output array; 2 represents the collimating lens unit; 3 represents the beam splitter unit; 4 represents the grating; 5 represents the focusing lens unit one; 6 represents transmitting lens unit; 7 represents the focusing lens unit two.

FIG. 8 illustrates the transmitting optical path with a reflecting grating in an embodiment of the present invention.

### DETAILED DESCRIPTION OF EXAMPLE EMBODIMENTS

The present invention is described in further detail below in connection with the accompanying drawings and specific embodiments.

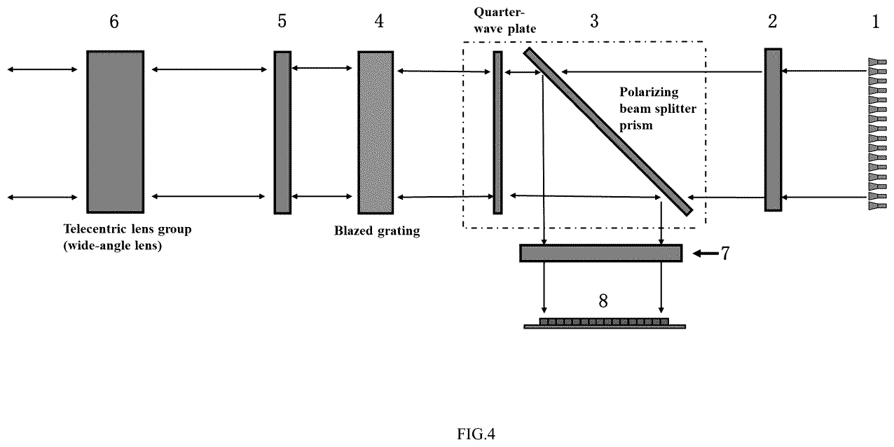

The solid-state LiDAR device adopts a coaxial transceiver circuit as shown in FIG. 4, including a laser output array 1, a collimating lens unit 2, a beam splitter unit 3, a grating 4, a focusing lens unit one 5, an transmitting lens unit 6, a focusing lens unit two 7, and a detector 8. Wherein the laser output array (1) comprises a number of tunable lasers. Wherein the tunable lasers in the same row have the same wavelength tuning range, and the tunable lasers in the same column have different wavelength tuning ranges. Different wavelength tuning ranges are superimposed to form a continuous total tuning wavelength range. Each of the tunable lasers emits an outgoing laser beam in the direction of the collimating lens unit 2. The wavelength tuning range of the outgoing laser beam Δλ is positively correlated with the size of the scanning range of the scanning laser beam emitted by the transmitting lens unit 6. The scanning laser beams generated by the outgoing lasers of different wavelengths have different propagation directions.

Wherein, the collimating lens unit 2/focusing lens unit one 5/transmitting lens unit 6/focusing lens unit two 7 may comprise a plurality of aspherical, cylindrical or spherical lenses. In a specific implementation, the collimating lens unit 2 comprises a plurality of aspherical, cylindrical or spherical collimating lenses. The focusing lens unit one 5 comprises a plurality of aspherical, cylindrical or spherical focusing lenses. The focusing lens unit two 7 comprises a plurality of aspherical, cylindrical or spherical focusing lenses. The transmitting lens unit 6 comprises a plurality of aspherical or spherical transmitting lenses. The above lenses may be coated with a reflective enhancement film or not.

Wherein, the grating 4 is a reflective blazed grating, the arrow in FIG. 4 passing through the grating 4 does not mean that the light is transmitted through the grating.

Wherein, the beam splitter unit 3 includes a polarizing beam splitter prism as well as a quarter-wave plate.

Collimating lens unit 2 and grating 4 are arranged in the emitting outgoing laser light path of the laser output array 1. The laser output array 1 emits lasers of different wavelengths sequentially. After the laser passes through the collimating lens unit 2, it is collimated as a straight laser, and after the collimated laser is incident on the grating 4, it is diffracted as a diffracted laser. After the diffracted laser is incident on the focusing lens unit one 5 through the grating 4, it is focused into a focused laser. The focused laser is incident on the transmitting lens unit 6, and finally the collimated beam of different directions is emitted towards the scanning direction through the transmitting lens unit 6 to scan in a large area. The receiving optical path adopts a coaxial transceiver optical system. The diffuse reflected light enters the optical system again through the transmitting lens unit 6. Because the optical path is reversible, the received light will pass through the focusing lens unit one 5, the grating 4, and the beam splitter unit 3 in turn. After passing through a quarter-wave plate, the direction of polarization is perpendicular to the original outgoing light. When passing through the polarization beam splitter prism again, the optical path is reversed and focused to the detector 8 through the focusing lens unit two 7.

Further, the solid-state LiDAR device comprises a reflection unit, the reflection unit comprising a plurality of aspherical, spherical, cylindrical or planar mirrors, and the number of mirrors can be adjusted according to the demand.

Further, the solid-state lidar scanning device comprises a beam expander and reducer unit, the beam expander and reducer unit comprising a plurality of aspherical, cylindrical, spherical, or planar mirrors for varying the aperture of the optical path through the system. The reflection unit as well as the beam expander and reducer unit are not shown in FIG. 4.

The radar device of the present invention uses a semiconductor laser array chip in combination with a solid-state LiDAR scanning system to achieve a greater range of scanning angles. The present invention proposes to perform multiple quantum well mixing of the semiconductor laser chip to increase the overall wavelength scanning range of its array output. In combination with the solid-state LiDAR scanning system, the chip enables a larger angular range of scanning (when the alignment direction is perpendicular to the grating grooves), which is greatly improved with respect to the existing technology. The scanning range becomes twice as large with this quantum well hybridized semiconductor laser array chip compared to a single laser source with a fixed wavelength tuning range.

In addition, when the array laser of the semiconductor laser array chip is arrayed in a direction parallel to the grating grooves' direction, the system in the fast-axis direction realizes scanning in one dimension through wavelength tuning, and in the slow-axis direction forms a line light spot through the laser array to scan in another dimension, thus realizing a two-dimensional LiDAR scanning effect.

Compared with the existing solid-state LiDAR technology, this 2D scanning solid-state LiDAR system has the advantages of large scanning range, simple scanning method, only controlling the wavelength of the laser, and low cost.

The steps of the scanning method of the above-described solid-state LiDAR device are as follows:
(S1) Turn on said solid-state LiDAR device and pre-set scanning parameters according to a ranging method.
(S2) Each tunable laser in the laser output array (1) tunes in their respective wavelength tuning range, and then sequentially emits laser of different wavelengths. The tuning method is discontinuous tuning or continuous tuning. The wavelength tuning is controlled by voltage. The wavelength of the outgoing laser belongs to the preset total wavelength tuning range. After the laser passes through the collimating lens unit 2, it is collimated as a straight laser, and after the collimated laser is incident on the grating 4, it is diffracted as a diffracted laser. After the diffracted laser is incident on the focusing lens unit one 5 through the grating 4, it is focused into a focused laser. The focused laser is incident on the transmitting lens unit 6, and finally the collimated beam of different directions is emitted towards the scanning direction through the transmitting lens unit 6 to scan in a large area. After the collimated beam emitted by the transmitting lens unit 6 irradiates the target object in the scanning direction, diffuse reflection is generated, and the reflected beam re-enters the optical system. Because the optical path is reversible, the received light will pass through the transmitting lens unit 6, the focusing lens unit one 5, the grating 4, and the beam splitter unit 3 in turn. After passing through a quarter-wave plate, the direction of polarization is perpendicular to the original outgoing light. When passing through the polarization beam splitter prism again, the optical path is reversed and focused to the detector 8 through the focusing lens unit two 7.

The relationship between wavelength tuning range Δλ and the scanning range angle Δθ of the scanning laser beam emitted by the transmitting lens unit 6 is

$$\begin{matrix}Δθ = 2 arctan ( \frac{s}{2 {f}_{2}} ) \\ s = 2 * {f}_{1} sin ( \frac{Δγ}{2} )\end{matrix}$$

Where s is the distance between the focusing point (or line light spot) formed by the maximum and minimum wavelength focused laser in the wavelength tuning range Δλ when the focused laser is incident on the focal plane of the transmitting lens unit 6. f₂ is the focal length of the transmitting lens unit 6. f₁ is the focal length of the focusing lens unit one 5. γ is the diffraction angle of the diffracted laser. Δγ is the diffraction angle range of the diffracted laser. Δθ is the scanning range angle (i.e. the angle formed by the two scanning lasers corresponding to the maximum and minimum wavelength focusing laser, respectively, at the center of the transmitting lens unit 6).

The diffraction angle range of diffractive lasers Δγ is approximately dγ/dλ*Δλ, where dγ/dλ is the angle dispersion of the diffracted laser, λ is the wavelength of the laser light emitted by the laser output array 1, and Δλ is the wavelength tuning range of the laser light emitted by the laser output array 1.

The grating 4 uses a blazed grating, and the formulas about the diffraction angle of the diffracted laser γ and dispersion dγ/dλ are as follows:

$$\begin{matrix}a ( sini + sin γ ) = m λ \\ \frac{d γ}{d λ} = \frac{m}{acos γ}\end{matrix}$$

Where α is the grating period of grating 4, i is the incidence angle of the collimated laser incident on the grating 4, and m is the diffraction order of the grating 4.

From the above equation, the scanning range angle Δθ of the solid-state LiDAR scanning device and the total wavelength tuning range Δλ are positively correlated.

Specific embodiments of the invention are as follows:

### Example 1

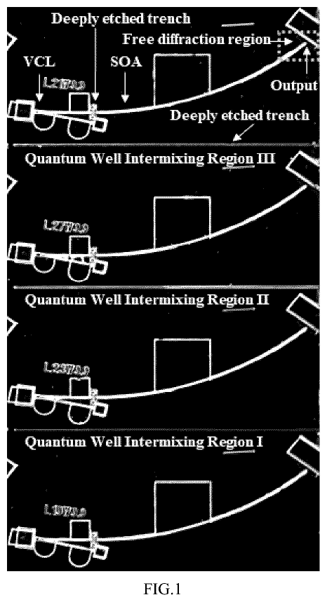

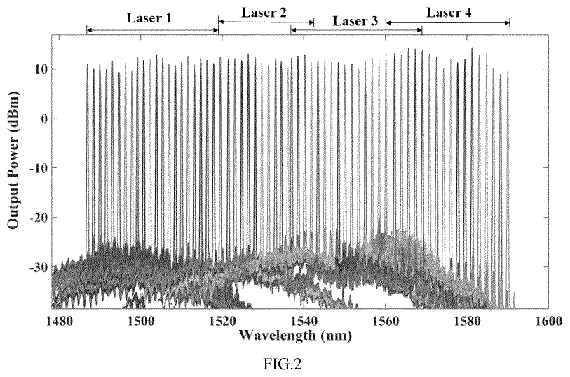

In specific implementation, the laser output comprises four array semiconductor tunable lasers, as shown in FIG. 1. Each semiconductor tunable laser is followed by a semiconductor optical amplifier integrated with deep groove coupling to increase the power. The laser output array has three quantum well promiscuous regions, corresponding to the regions where the three semiconductor tunable lasers are located, It is used to change the band width of the material in this region, so as to expand the wavelength tuning range of the laser array output. Each quantum well promiscuous region is separated by a deep etching groove. FIG. 2 shows the output spectrum of the laser output array at a single temperature of 15° C., with a tuning range of 103 nm from 1486.9 to 1589.9 nm. The collimating lens unit 2 adopts a collimating lens. The grating 4 adopts a blazed grating. The focusing lens unit one 5 adopts a focusing lens. The transmitting lens unit 6 adopts an transmitting lens. The reflection unit can also be arranged between the focusing lens unit one 5 and the transmitting lens unit 6. The reflection unit adopts a reflector. The array is arranged perpendicular to the grating grooves, and the output array is located in the focal plane of the collimating lens unit.

The grating period a of the blazed grating 4 is 1.667 μm, the blaze angle of the blazed grating 4 is 28.68°, the focal length f₁ of the focusing lens unit one 5 is 100 mm, and the focal length f₂ of the transmitting lens unit 6 is 3.1 mm.

To maximize the angle dispersion of the diffracted laser, according to the formula for angle dispersion, when the diffraction order m and the grating constant of the blazed grating a is fixed, the larger the diffraction angle of the diffracted laser is, the larger the angle dispersion is.

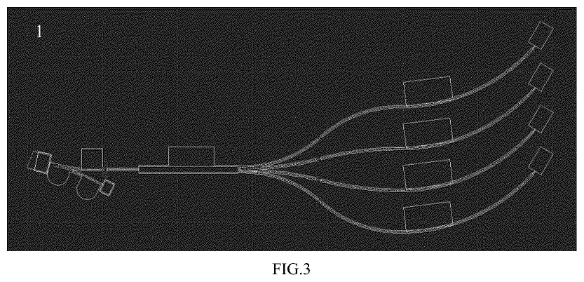

According to the diffraction principle of the blazed grating, as shown in FIG. 3, the blaze direction of the blazed grating and the incidence direction of the collimating laser are symmetrical about the normal line of the etching surface of the grating. According to the formula for the diffraction angle γ of the diffracted laser, the diffraction formula of the blazed grating is as follows:

$$a * [ sin ( 28.68 ° + α ) + sin ( 28.68 ° - α ) ] = m λ$$

Where α is the angle between the blaze direction of the blazed grating 4 and the normal line of the etched surface of the blazed grating 4.

When the diffraction order m is 1 and the wavelength λ of the laser light emitted by the tunable semiconductor laser is 1.55 μm, according to the above diffraction equation we obtain: α=14.360, the diffraction angle of the diffracted laser γ=28.68°+α=28.68°+14.36°=43.04°.

From the role dispersion equation, one is obtained: dγ/dλ=0.821 μm⁻¹. The diffraction angle range of the diffracted laser Δγ is approximately dγ/dλ*Δλ=4.85°.

When the focused laser is incident on the transmitting lens, according to the formula for the distance s between the focal point of the maximum wavelength focused laser and the focal point of the minimum wavelength focused laser on the transmitting lens, we can obtain:

$$s = 2 * {f}_{1} sin ( \frac{Δ γ}{2} ) = 2 * 100 * sin ( 2.425 ° ) = 8.46 mm$$

According to the collimated beams in different directions emitted by the transmitting lens, whose scanning range angle Δθ formed by continues scanning of different directions, one can obtain: Δθ=2*arctan (s/2f₂)=2*arctan(1.365)=107.5°. The scanning range of this LiDAR scanning device is greatly improved. At the same time, the diffuse reflected light scanned into the object passes through the transmitting lens unit, the focusing lens unit one, and then through the grating to combine wave, and then focuses on the single-point detector through the focusing lens unit two to realize the detection.

### Example 2

In the specific embodiment, 2D scanning of a solid-state LiDAR is realized using this system with FOV parameters of 120°×80°, a resolution of 192×128, and an angular resolution of 0.625×0.625.

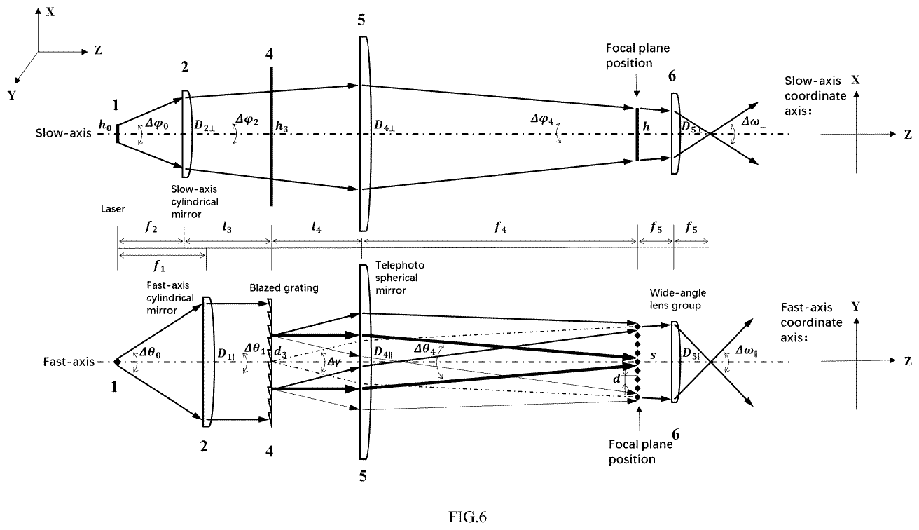

Laser output array 1 consists of a 905 nm band tunable semiconductor laser integrated with a 1×4 MMI and semiconductor optical amplifiers to realize the laser array output. The four ports will be illuminated at the same time, and the wavelength will be tuned in chronological order, with a tuning range of 20 nm. As shown in FIG. 3, the output port span is 400 μm. The collimating lens unit 2 adopts a cylindrical lens group to collimate the slow and fast axes of the laser output array, respectively. The grating 4 adopts a blazed grating, which is a one-dimensional grating with a grating period of 0.833 μm and ablaze angle of 36.87°. Then according to the grating equation, the diffraction angle range Δγ corresponding to the 905 nm band and the tuning range of 20 nm is 2.93°. The layout direction of the laser output array 1 (i.e., the direction of the slow-axis) is the same as the direction of the grating grooves of the grating 4. The fast-axis direction realizes scanning in the X-Z plane through wavelength tuning, and the slow-axis direction realizes irradiation in the Y-Z plane through the formation of a line light spot by the laser output array 1, thus realizing the two-dimensional LiDAR scanning effect shown in FIG. 6.

The slow and fast axes of the laser are described in the following: FIG. 6 shows the transmitting paths for the slow and fast axes, respectively. Because it is only the transmitting path, the beam splitter unit is not shown, which in this system is a polarizing beam splitter prism and a quarter-wave plate.

For the fast-axis transmitting optical path, the collimating lens unit 2 uses a cylindrical mirror to collimate lasers emitted by the laser output array 1. The output port of the laser output array 1 is located on one side of the focal plane of the cylindrical mirror, and the fast-axis is perpendicular to the direction of the grating grooves of the blazed grating 4, where diffraction occurs. A certain range of wavelengths Δλ corresponds to a certain range of diffraction angle Δγ. The diffracted light is focused on one side of the focal plane of the transmitting lens unit 6 by the focusing lens unit one 5. The diffracted light corresponding to different wavelengths of the emitted laser light has different diffraction angles. And then after passing through the focusing lens unit one 5, the light corresponds to different positions in the focal plane of the transmitting lens unit 6. Different focused spots in the positions of the focal plane correspond to different wavelengths.

In this embodiment, the focusing lens unit one 5 adopts a long-focus spherical mirror with a focal length f₄ of 100 mm. The scanning span s (the distance between the line light spot formed by the maximum and minimum wavelength focused laser) of the line light spot at the confocal plane of the focusing lens unit one 5 and the lens unit 6 (i.e., the focal plane of the lens unit 6 near the side of the laser output array 1) is as follows:

$$s = 2 * {f}_{4} * tan ( Δγ / 2 ) = 5.1 \; 15 mm$$

Where f₄ is the focal length of the focusing lens unit one 5, and Δγ is the diffraction angle range.

The horizontal FOV is 120°, i.e. Δw_{∥}=120°. The formula for the calculation of the horizontal field of view (horizontal FOV) Δw_{∥} is:

$$Δ {w}_{\vert \vert} = 2 * arctan ( \frac{s}{2} / {f}_{5} )$$

Where f₅ is the focal length of the lens unit 6, and Δw_{∥} is horizontal field of view (horizontal FOV).

In this embodiment, the horizontal field of view (horizontal FOV) Δw_{∥}=120°. The focal length of the lens unit 6 f₅ is 1.477 mm. In the dimension corresponding to the fast-axis, the resolution is 192 pixels. This results in the spot size d of the focusing point on the confocal planed is:

$$d = \frac{s}{192} = 0.0 \; 27 mm$$

Where d is the spot size of the focusing point on the confocal plane, and s is the scanning span of the line light spot.

In addition, one of the factors limiting the spot size d of the focusing point on the confocal planed is the Airy spot diameter of the system:

$$d = 2 * 1.22 * λ * {f}_{4} / {D}_{4 \vert \vert}$$

Where λ is the incident wavelength, f₄ is the focal length of the focusing lens unit one 5, D_{4∥} is the clear aperture of the focusing lens unit one 5 in the fast-axis direction, and d is the spot size of the focusing point on the confocal plane.

In this embodiment, λ=0.905 m, f₄=100 mm, d=0.027 mm, so we obtain D_{4|}=8.289 mm.

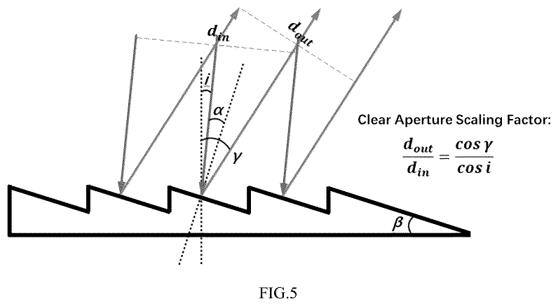

As shown in FIG. 5, the blazed grating 4 has a clear aperture scaling factor:

$${d}_{out} / {d}_{i n} = cos γ / cos i$$

Where γ is the grating diffraction angle, and i is the grating incidence angle. dₒᵤₜ=D_{4∥}, dᵢₙ=d3.

The width of the irradiated area of the grating d3 is calculated by the formula:

$$d 3 = ( {D}_{4 \vert \vert} - 2 * {l}_{4} * tan ( {Δθ}_{1} / 2 ) ) * cos i / cos γ$$

Where d3 is the width of the irradiated area of the grating 4, and l₄ is the distance between the grating 4 and the focusing lens unit one 5. l₄=30 mm. Δθ_{⊥} is the fast-axis divergence angle of the collimating lens unit 2, i.e., the divergence angle of the column mirror (collimating lens unit 2) after collimation in the fast-axis direction.

Fast-axis divergence angle Δθ_{⊥} is:

$$Δ {θ}_{1} = 2 * arctan ( d / 2 / {f}_{4} ) = 0.02 °$$

Where f₄ is the focal length of the focusing lens unit one 5, and d is the spot size of the focusing point on the confocal plane.

According to the grating equation, we can obtain that grating incidence angle i=11.710 and grating diffraction angle γ=62.030. According to the formula calculating the width of the irradiated area of the grating d3, we obtain d3=17.289 mm.

The collimating lens unit 2 uses a collimating cylindrical mirror. The clear aperture of the collimating lens unit 2 D1_{∥} in fast-axis direction is:

$$D {1}_{\vert \vert} = d 3 - 2 * {l}_{3} * tan ( {Δθ}_{1} / 2 ) = 17.287 mm$$

Where D1_{∥} is the clear aperture of the collimating lens unit 2 in the fast-axis direction, d3 is the width of the irradiated area of the grating 4, Δθ_{⊥} is the fast-axis divergence angle of the collimating lens unit 2, and L₃ is the distance between the collimating lens unit 2 and the grating 4. In the present embodiment l₃=30 mm.

The focal length of the collimating lens unit 2 in the fast-axis direction is:

$${f}_{1} = D {1}_{\vert \vert} / 2 / tan ( {Δθ}_{0} / 2 ) = 2 9.17 mm$$

Where f_{⊥} is the focal length of collimating lens unit 2 in the fast-axis direction, D1_{∥} is the clear aperture of the collimating lens unit 2 in the fast-axis direction, and Δθ₀ is the fast-axis divergence angle of the laser output array 1. In this embodiment, Δθ₀=33°.

For the slow-axis transmitting optical path, the light source is equivalent to the line light spot formed by the laser array output port. The slow-axis divergence angle of the laser output array 1 Δφ₀ is 15°. Because the slow-axis direction is parallel to the grating grooves, the grating 4 does not diffract the light in the slow-axis direction. The light is focused by the focusing lens unit one 5, and forms a line light spot of a certain length h on the focal plane of the transmitting lens unit 6. This line light spot is the image formed through the optical system by the line light spot corresponding to the output port of the laser output array 1.

Through the transmitting lens unit 6, the line light spot continues to propagate outward (scanning area) at a certain angle Δω⊥.

In this embodiment, the vertical field of view (vertical FOV) Δw_{⊥}=80°. According to the formula calculating the vertical field of view (vertical FOV) Δw_{⊥}:

$$Δ {w}_{⊥} = 2 * arctan ( h / 2 / {f}_{5} )$$

Where Δw_{⊥} is the vertical field of view (vertical FOV), h is the line light spot length, and f₅ is the focal length of the lens unit 6.

In this embodiment, Δw_{⊥}=80°, f5=1.477 mm. Thus, we obtain the line light spot length h=2.478 mm. The line light spot length is specifically the length of the line light spot formed in the direction of the slow-axis at the confocal plane of the telephoto spherical mirror (focusing lens unit one 5) and the wide-angle lens group (transmitting lens 6).

Under the paraxial approximation, it is obtained from the formula for optical invariance:

$$\frac{{h}_{0}}{2} * tan ( \frac{Δ {ϕ}_{0}}{2} ) = \frac{h}{2} * tan ( \frac{Δ {ϕ}_{4}}{2} ) = \frac{{D}_{2 ⊥}}{2} * tan ( \frac{Δ {ϕ}_{2}}{2} )$$

Where h₀ is the dimension of the laser output array 1 in the slow-axis direction, Δφ₀ is the slow-axis divergence angle of the laser output array 1, h is the line light spot length, Δφ₄ is the convergence angle of the outgoing laser light in the slow-axis direction through the focusing lens unit one 5, D_{2⊥} is the clear aperture of the collimating lens unit 2 in the slow-axis direction, Δφ₂ is the slow-axis divergence angle of the collimating lens unit 2, i.e., the divergence angle after collimated by the collimating lens unit 2 in the slow-axis direction.

The clear aperture D_{2⊥} of the collimating lens unit 2 in the slow-axis direction calculating formula is:

$$\begin{matrix}{D}_{2 ⊥} + 2 * ( {l}_{3} + {l}_{4} ) * tan ( \frac{{Δφ}_{2}}{2} ) = {D}_{4 ⊥} \\ {D}_{4 ⊥} = h + 2 * {f}_{4} * tan ( \frac{{Δφ}_{4}}{2} )\end{matrix}$$

Where D_{2⊥} is the clear aperture of the collimating lens unit 2 in the slow-axis direction, l₃ is the distance between the collimating lens unit 2 and the grating 4, l₄ is the distance between the grating 4 and the focusing lens unit one 5, Δφ₂ is the divergence angle in the slow-axis, D_{4⊥} is the clear aperture of the collimating lens unit one 5 in the slow-axis direction, h is the line light spot length, f₄ is the focal length of the focusing lens unit one 5, and Δφ₄ is the convergence angle of the emitted laser light in the slow-axis direction through the focusing lens unit one 5.

In this embodiment, l₃=30 mm, l₄=30 mm, h=2.478 mm, f₄=100 mm. Thus, we obtain the clear aperture of the collimating lens unit 2 in the slow-axis direction D_{2⊥}=6.755 mm.

In addition, the relationship equation between the clear aperture and the focal length of the collimating lens unit 2 in the slow-axis direction is:

$${h}_{0} + 2 * {f}_{2} * tan ( \frac{{Δφ}_{0}}{2} ) = {D}_{2 ⊥}$$

Where h₀ is the dimension of the laser output array 1 in the slow-axis direction, f₂ is the focal length of the collimating lens unit 2 in the slow-axis direction, Δφ₀ is the divergence angle of the laser output array 1 in the slow-axis direction, and D_{2⊥} is the clear aperture of the collimating lens unit 2 in the slow-axis direction.

In this embodiment, h₀=400 m, Δφ₀=15°, D_{2⊥}=6.755 mm. The focal length of the slow-axis cylindrical mirror (collimating lens unit 2) f₂=24.134 mm can be obtained according to the equation for the relationship between the clear aperture and the focal length in the slow-axis direction of the collimating lens unit 2.

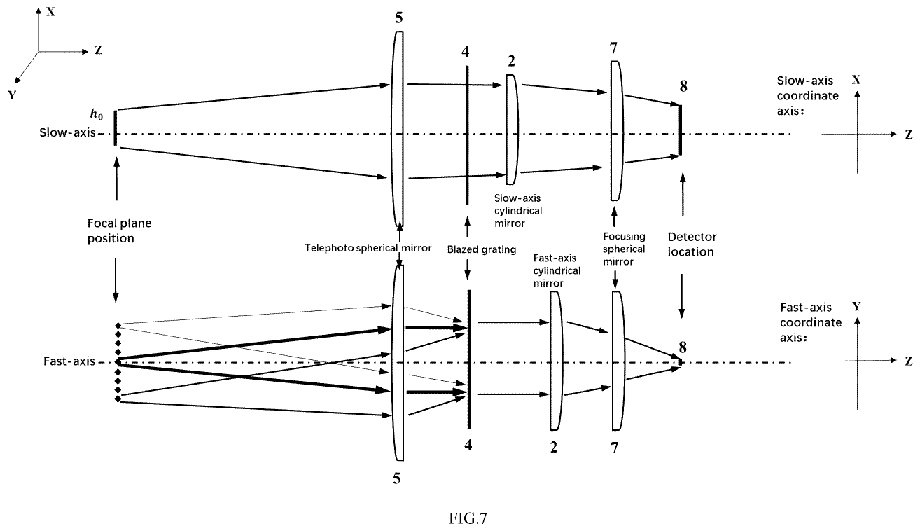

FIG. 7 shows the fast-axis and slow-axis receiving optical paths. As the optical path is reversible, the diffuse reflected light from the outside world is imaged at the focal plane through the transmitting lens 6. Then it passes through the focusing lens unit one 5, the grating 4, the collimating lens unit 2 sequentially. The optical path is refolded by the beam splitter unit 3 (the beam splitter unit is not shown in the figure), and the light is finally focused to the detector through the focusing lens unit two 7. In the present embodiment, the detector uses a line array detector, and the focusing lens unit two 7 uses a converging spherical mirror. In the direction of the slow-axis, the spot size that is focused to the light-receiving surface of the detector 8 through the focusing lens unit two 7 should be consistent with the length of the linear array detector 3.584 mm. In the fast-axis direction, the spot size through the focusing lens unit two 7 onto the detector shall be less than the width of the line array detector by 0.2 mm.

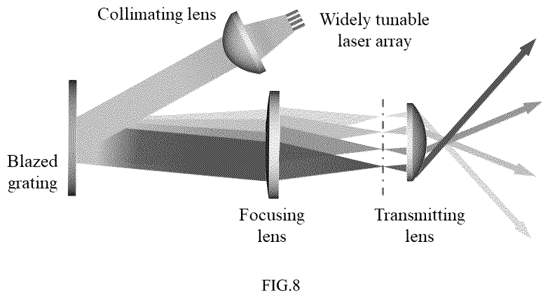

In FIGS. 4, 6 and 7, the blazed grating is illustrated as a transmissive grating for convenience. More commonly it is implemented as a reflecting brazed grating as shown in FIG. 5. FIG. 8 illustrates the transmitting optical path with a reflecting grating in an embodiment of the invention. Similarly, one or more of the spherical or cylindrical lenses can also be implemented as a reflecting concave mirror to make the device more compact. The solid-state LiDAR device may further comprise a reflection unit, said reflection unit comprising one or a combination of one or more of aspherical, cylindrical, spherical, planar mirror and reflecting grating. The solid-state LiDAR scanning device may further comprise a beam expander and beam reducer unit, which may comprise a combination of one or more of aspherical, cylindrical, spherical and planar lenses or mirrors.

The present invention is illustrated in accordance with embodiments. A number of deformations and improvements can be made to the device without departing from the present principles. It should be noted that all technical solutions obtained by means of equivalent substitution or equivalent transformation, etc., fall within the scope of protection of the present invention.

What is claimed is:

1. A solid-state LiDAR device based on a tunable laser output array, comprising a tunable laser output array (1), a collimating lens unit (2), a beam splitter unit (3), a grating (4), a focusing lens unit one (5), a transmitting lens unit (6), a focusing lens unit two (7) and a detector (8).
Said tunable laser output array (1) emits N-channel outgoing laser, which are respectively collimated by the collimating lens unit (2). And then N-channel outgoing laser are transmitted through the beam splitter unit (3) to the grating (4), where diffraction occurs. After diffraction, they are focused by the focusing lens unit one (5) and then refracted by the transmitting lens unit (6) to become the N-channel scanning laser. The scanning laser generated by different wavelengths of the emitted laser has different propagation directions.
When the N-channel scanning laser is emitted to the scanning area, it is diffusely reflected by the objects in the scanning area and generates the N-channel return laser respectively. After returning to the beam splitter unit (3) along the original path, the N-channel return laser is reflected to the focusing lens unit two (7), and then focused to the detector (8).

2. The solid-state LiDAR device of claim 1 wherein said tunable laser output array (1) comprises a plurality of lasers arranged in several arrays. Said lasers array in the focal plane of the collimated lens unit (2). Said collimated lens unit (2) is disposed on the light-emitting side of the tunable laser output array (1).

3. The solid-state LiDAR device of claim 2 wherein said tunable laser output array (1) comprises N tunable lasers arranged in several arrays along a P×Q matrix, the row direction of said P×Q matrix is parallel to the grating grooves of the grating (4), and the column direction is perpendicular to the grating grooves of the grating (4). The total number of rows P and total number of columns Q are both greater than or equal to 1, but the total number of rows P and the total number of columns Q are not 1 at the same time. The Q tunable lasers in the same row have the same wavelength tuning range, and the P tunable lasers in the same column have k different wavelength tuning ranges respectively. The K different wavelength tuning ranges are superimposed to cover or equal to the predetermined total wavelength tuning range. K is less than or equal to the total number of rows P.

4. The solid-state LiDAR device of claim 3 wherein said tunable laser is a side-emitting semiconductor laser with a total number of rows P of 1, and the detector (8) is a line array detector.
Alternatively, said tunable laser is a side-emitting semiconductor laser with a total number of columns Q of 1, and the detector (8) is a single point detector.

5. The solid-state LiDAR device of claim 4 wherein said side-emitting semiconductor lasers is realized by modifying the active region of each side-emitting semiconductor laser by using quantum well mixing technology.

6. The solid-state LiDAR device of claim 1 wherein said grating (4) is a blazed grating. Said collimating lens unit (2)/focusing lens unit one (5)/transmitting lens unit (6)/focusing lens unit two (7) all comprise a plurality of lenses. Said lenses are aspherical, cylindrical, or spherical lenses, and are coated with a reflection enhancement film or uncoated.

7. The solid-state LiDAR device of claim 1 wherein said beam splitter unit (3) comprises a polarizing beam splitter prism and a quarter-wave plate, said polarizing beam splitter prism and quarter-wave plate being arranged sequentially along the propagation direction of the outgoing laser light.

8. The solid-state LiDAR device of claim 1 further comprises a reflection unit, said reflection unit comprising one or a combination of one or more of aspherical, cylindrical, spherical, planar mirror and reflecting grating; said solid-state LiDAR scanning device further comprises a beam expander and beam reducer unit, said beam expander and beam reducer unit comprising a combination of one or more of aspherical, cylindrical, spherical lenses and mirrors.

9. A scanning method of a solid-state LiDAR device include the steps as follows:
(S1) Turn on said solid-state LiDAR device.
(S2) The individual tunable lasers in the laser output array (1) are tuned in their respective wavelength tuning ranges and emit outgoing lasers of different wavelengths in a chronological order. Said tuning is discontinuous or continuous, and the wavelengths of said outgoing lasers all fall within a pre-set total wavelength tuning range. After sequentially passing through the collimating lens unit (2) and beam splitter unit (3), each outgoing laser is diffracted when incident in the grating (4) to generate a diffractive laser. The diffractive laser is incident on the focusing lens unit one (5) and then focused into a focused laser. The focused laser is incident on the focal plane of the transmitting lens unit (6), and after being refracted by the transmitting lens unit (6) a scanning laser is generated. The scanning laser is irradiated to the object in the scanning area, and the return laser is formed by diffuse reflection. The return laser is collected by the detector (8) after passing through the transmitting lens unit (6), the focusing lens unit one (5), the grating (4), the beam splitter unit (3), and the focusing lens unit two (7) in turn.
(S3) Said detector (8) transmits the collected return laser signals to an external controller, wherein said controller processes the received return laser signals to generate a scan result:
(S4) At the end of the scanning, turn off said solid-state LiDAR device.

10. The scanning method of claim 9, wherein said step (S2), when there is only one column of tunable lasers having the same wavelength tuning range, outgoing lasers emitted from the same column of tunable lasers having the same wavelength form a single line light spot on the focal plane of the transmitting lens unit (6), and outgoing lasers of different wavelengths form a plurality of parallel spaced line light spot. When there is only one row of tunable lasers, outgoing lasers emitted from the same line of tunable lasers having the same wavelength form a point spot on the focal plane of the transmitting lens unit (6), and outgoing lasers having different wavelengths form a plurality of point spots, said point spots being arranged along a straight line, said straight line direction being perpendicular to the direction of the line light spots.
